(19) United States
(12) Patent Application Publication
(10) Pub. No.: US 2025/0260478 A1
(43) Pub. Date: Aug. 14, 2025

(54) DIVERSITY COMBINING A USER UPLINK IN A SATELLITE COMMUNICATION SYSTEM

(71) Applicant: Hughes Network Systems, LLC, Germantown, MD (US)

(72) Inventors: Lin-Nan LEE, Potomac, MD (US); Victor LIAU, Germantown, MD (US); Mustafa EROZ, Germantown, MD (US)

(21) Appl. No.: 18/437,222

(22) Filed: Feb. 8, 2024

(51) Int. Cl. H04B 7/185; H04W 36/30

(52) U.S. Cl. CPC H04B 7/18513; H04B 7/18519; H04W 36/302

(57) ABSTRACT

A system and method for enhancing a user uplink for satellite communications, including: maintaining a serving reception of the user uplink at a serving satellite; selecting a diversity satellite moving into a competitive position as compared to an elevation angle of the serving satellite; forming a diversity reception of the user uplink at the diversity satellite; and diversity combining the serving reception and the diversity reception to enhance the user uplink for a period longer than a handoff period, wherein the diversity combining is performed while a signal strength difference between the serving reception and the diversity reception is less than or equal to a predefined limit.

### FIELD

The present teachings enhance a user uplink from a User Equipment to a satellite by diversity combining an uplink signal received by a plurality of satellites.

### BACKGROUND

Satellite communication systems are widely used for various applications such as broadcasting, navigation, weather monitoring, and telecommunications. In these systems, the quality of the communication link is often affected by various factors such as atmospheric conditions, satellite movement, and signal interference. One of the challenges in satellite communication is maintaining a strong and reliable uplink, which is the connection from a user's device to the satellite. The strength and reliability of the uplink can be affected by the satellite's elevation angle, which is the angle between the horizon and the satellite. A low elevation angle can result in a weak uplink, while a high elevation angle can result in a strong uplink. However, the elevation angle changes as the satellite moves, which can cause fluctuations in the uplink strength. Therefore, there is a need for techniques to maintain a strong and reliable uplink in satellite communication systems.

Previous approaches have focused on selecting an alternative satellite for handoff when a relative movement between a serving satellite and a terminal disposes the terminal in a non-coverage area of the serving satellite. The prior art approaches have failed to use diversity combining to enhance a user uplink signal received at multiple satellites.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In some aspects, the techniques described herein relate to a process for enhancing a user uplink for satellite communications, including: maintaining a serving reception of the user uplink at a serving satellite; selecting a diversity satellite moving into a competitive position as compared to an elevation angle of the serving satellite; forming a diversity reception of the user uplink at the diversity satellite; and diversity combining the serving reception and the diversity reception to enhance the user uplink for a period longer than a handoff period, wherein the diversity combining is performed while a signal strength difference between the serving reception and the diversity reception is less than or equal to a predefined limit.

In some aspects, the techniques described herein relate to a process, wherein the predefined limit is 4 dB, beyond which the gain is diminishing, as an example.

In some aspects, the techniques described herein relate to a process, wherein the diversity combining enhances the user uplink by at least 1.4 dB at a serving receiver or corresponding to a predefined gain floor.

In some aspects, the techniques described herein relate to a process, wherein the diversity combining is performed at a serving receiver for the user uplink.

In some aspects, the techniques described herein relate to a process, wherein the serving receiver performs a channel estimation and a Doppler compensation on the serving reception and accepts the diversity reception from a diversity receiver, prior to the diversity combining.

In some aspects, the techniques described herein relate to a process, wherein a diversity receiver performs a channel estimation and a Doppler compensation on the diversity reception prior to the diversity combining.

In some aspects, the techniques described herein relate to a process, wherein the diversity reception is communicated via an Inter-Satellite Link (ISL) for the diversity combining.

In some aspects, the techniques described herein relate to a process, wherein the diversity reception is established as the serving reception when the signal strength difference is less than the predefined limit.

In some aspects, the techniques described herein relate to a process, wherein one user downlink to a user device is paired with the serving reception and the diversity reception.

In some aspects, the techniques described herein relate to a process, wherein the maintaining of the serving reception is terminated to conserve a transmission power of the serving satellite.

In some aspects, the techniques described herein relate to a system to enhance a user uplink for satellite communications, including: a serving receiver to maintain a serving reception of the user uplink at a serving satellite; a diversity satellite to move into a competitive position as compared to an elevation angle of the serving satellite and to form a diversity reception of the user uplink at the diversity satellite; and a diversity combiner to enhance the serving reception and the diversity reception for a period longer than a handoff period, wherein the diversity combiner operates while a signal strength difference between the serving reception and the diversity reception is less than or equal to a predefined limit.

In some aspects, the techniques described herein relate to a system, wherein the predefined limit is 4 dB.

In some aspects, the techniques described herein relate to a system, wherein the diversity combiner enhances the user uplink by at least 1.4 dB at a serving receiver.

In some aspects, the techniques described herein relate to a system, wherein the diversity combiner operates at a serving receiver for the user uplink.

In some aspects, the techniques described herein relate to a system, wherein the serving receiver performs a channel estimation and a Doppler compensation on the serving reception and accepts input from a diversity receiver, prior to the diversity combiner.

In some aspects, the techniques described herein relate to a system, wherein the diversity receiver performs a channel estimation and a Doppler compensation on the diversity reception prior to the diversity combiner.

In some aspects, the techniques described herein relate to a system, further including an Inter-Satellite Link (ISL) to communicate the diversity reception to the diversity combiner.

In some aspects, the techniques described herein relate to a system, wherein the diversity reception is established as the serving reception when the signal strength difference is less than the predefined limit.

In some aspects, the techniques described herein relate to a system, wherein one user downlink to a user device is paired with the serving reception and the diversity reception.

In some aspects, the techniques described herein relate to a system, wherein the serving reception is terminated to conserve a transmission power of the serving satellite.

Additional features will be set forth in the description that follows, and in part will be apparent from the description, or may be learned by practice of what is described.

### DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1 illustrates a system to enhance a user uplink for satellite communications according to various embodiments.

FIG. 2 illustrates expected gains for diversity combining for various beam strength differences between a serving reception and diversity reception, according to various embodiments.

FIG. 3 is a flowchart of an example method for enhancing a user uplink for satellite communications.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

Multiple satellites at different positions in the sky may receive a user uplink signal. Examples include a moving satellite operating with a fixed cell on Earth architecture, non-synchronous satellites that form many beams that shine on earth and the like. With non-synchronous satellites, such as Low Earth Orbit (LEO) satellites, each beam tracks a specific cell or portion of a coverage area. At any given time, terminals disposed in the cell select a unique serving satellite based on its more favorable elevation angle for the cell. To avoid inter-satellite interference, only one satellite can serve the terminals in the cell in the downlink. Moreover, the user uplink is received by the same serving satellite, as uplink and downlink are paired. This pairing is maintained even though other satellites may be in line-of-sight (LOS) and may receive user uplinks from the terminals in the cell, as the directivity of the antenna used with a user terminal is broad. Additionally, other satellites in LOS do not “receive” the user uplink as no receive beam is formed by the other LOS satellites towards the cell. The “receive” signifies that a user uplink may impinge on the other LOS satellites antennae, but it is treated as noise as no beam towards the cell is formed.

Diversity combining involves propagating a transmitted signal, receiving the transmitted signal at multiple received signals at multiple antennas and combining the multiple received signals to enhance the reception of the transmitted signal. The present teachings combine a user uplink signal as received at antennas of multiple satellites to enhance the overall performance of the user uplink.

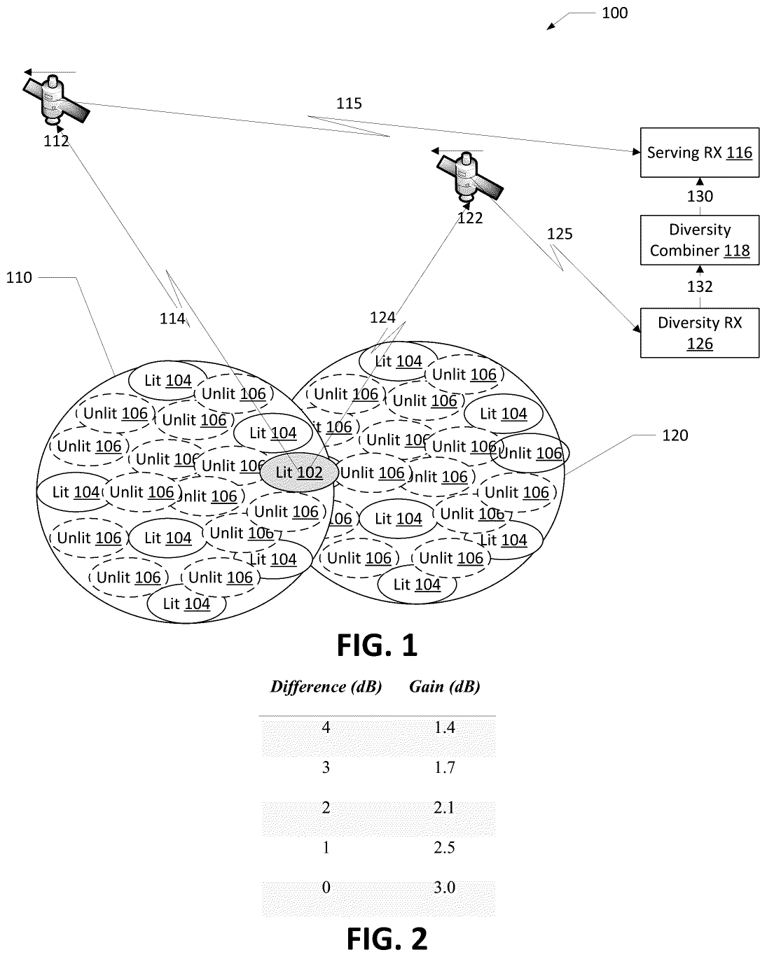

FIG. 1 illustrates a system to enhance a user uplink for satellite communications according to various embodiments.

A system 100 may include a serving satellite 112 having line-of-sight (LOS) with a coverage area 110 and a diversity satellite 122 having LOS with a coverage area 120. Coverage area 110 and coverage area 120 may be tessellated into cells that are classified as unlit cells 106, lit cells 104, and a dimly lit cell 102. Dimly lit cell 102 may be cells with a low elevation angle with respect to serving satellite 112.

The serving satellite 112 may be receiving a serving uplink 114 from a user equipment (UE) (not shown) disposed in dimly lit cell 102.

In the present teachings, when diversity satellite 122 is in LOS with a reasonable elevation angle and is capable of forming a diversity uplink 124 towards the UE disposed in the dimly lit cell 102, the serving uplink 114 may be enhanced by diversity combining serving uplink 114 with diversity uplink 124 at a diversity combiner 118. In some embodiments, the diversity combiner 118 may receive the serving uplink 114 as a serving downlink 115 from serving satellite 112 to a serving receiver 116. In some embodiments, a diversity receiver 126 may receive diversity uplink 124 as a diversity downlink 125 from diversity satellite 122.

The serving receiver 116 may be disposed on the ground. The diversity combiner 118 may be disposed near or within serving receiver 116. The serving receiver 116 may provide serving downlink 115 to diversity combiner 118. The diversity combiner 118 may combine serving uplink 114 (or serving downlink 115) with diversity uplink 124 (or diversity downlink 125) to provide an enhanced uplink 130 to serving receiver 116. Serving receiver 116 may pre-process serving downlink 115 for Doppler compensation, channel estimation and interference mitigation before diversity combiner 118.

The diversity receiver 126 may be disposed near or within serving receiver 116. Diversity receiver 126 may be disposed on the ground. In some embodiments, diversity receiver 126 may be connected to serving receiver 116 and/or diversity combiner 118 via a link 132. Diversity receiver 126 may provide diversity downlink 125 to diversity combiner 118. Diversity receiver 126 may pre-process diversity downlink 125 for Doppler compensation, channel estimation and interference mitigation before diversity combiner 118.

For diversity combining at diversity combiner 118 to be helpful, diversity uplink 124 at diversity satellite 122 must be reasonably strong, even if diversity uplink 124 is weaker than serving uplink 114 at serving satellite 112. This typically happens when serving satellite 112 is at a relatively low elevation angle while diversity satellite 122 is moving into a competitive elevation angle as compared to the elevation angle of serving satellite 112 as viewed from a UE in the dimly lit cell 102.

Azimuth and elevation are measures in degrees used to identify the position of a satellite flying overhead. Azimuth tells you what direction to face and elevation tells you how high up in the sky to look. Azimuth varies from 0° to 360°. It starts with North at 0°/360°, East at 90°, South at 180° and West at 270°. Elevation is also measured in degrees. A satellite just barely rising over horizon would be at 0° Elevation, and a satellite directly overhead would be at 90° Elevation (a.k.a., “the zenith”).

Satellites at low elevation angle suffer from higher propagation loss due to longer slant range and greater scan loss in addition for phase-array based antennas. For a respective coverage area, given two LOS satellites with a first satellite descending towards a lower elevation angle and a second satellite ascending towards a higher elevation angle, the second satellite is moving to a competitive position as compared to the first satellite. Link enhancement through diversity combining can be very beneficial not only before but also after an inter-satellite handoff, as the handoff typically occurs at the lowest elevation angle covered by both satellites. In some embodiments, diversity combining extends a duration for “make before break” handoff.

At any given time, a dimly lit cell 102 that is experiencing handoffs between satellites is typically located near an edge of coverage area (here coverage area 110) of a serving satellite along a belt nearly equal distance to serving satellite 112 and diversity satellite 122. To compensate for this a small portion of coverage area 110 and coverage area 120 may overlap.

The task for the diversity satellite 122 to form additional receive beams is a minor addition to the responsibility to serve its own coverage area 120. Due to hardware complexity constraint, a phase array-based satellite antenna typically has limited number of beams to be supported at a time. The number of beams may be further limited by the total power available for transmit beams.

Furthermore, active receive beams at a satellite may be constrained by upper layer protocols that pairs transmit and receive beams. As such, the present teachings provide for forming unpaired receive beams to support neighboring satellites for diversity reception. Moreover, to minimize the overhead to set up and tear down diversity reception, the extra receive beams may support cells on the satellites. In some embodiments, after an extended handoff period, a diversity reception (beam) becomes a serving reception (beam).

In some embodiments, the receive beams can always be utilized effectively independent of the number of transmit beams used at a satellite. More receive beams than transmit beams may be accommodated in antenna design to implement uplink diversity combining for other satellites in addition to those needed to pair with the transmit beams.

The diversity satellite may transfer its received signal to a receiver that tracks the serving satellite for combining with the serving signal from the serving satellite. Some increase in feeder link capacity may be provided to accommodate an increased number of receive beams. The link 132 may be provided on a network provider's backbone or network core. In some embodiments, the link between the receivers for the serving and diversity satellites may exist as they are often collocated and tightly connected to support the inter-satellite handoff. A selection switch (not shown) used for handoff in the serving receiver may be augmented with the diversity combiner. The link between the serving and diversity receivers ensures that the two uplink received signals passing through respective feeder links reach a single physical location for diversity combining processing. In some embodiments, the receivers and gateways of satellites may be co-located.

In some embodiments, the diversity and serving satellites may be connected with an Inter-satellite Link (ISL), and the link between the serving and diversity receivers may traverse the ISL to reach a diversity combiner.

In some embodiments, the diversity and serving satellites include “on-board processing”, where the demodulation (including Doppler correction) and decoding may be performed on-board the satellite. In such embodiments, the diversity combining may be performed on the serving satellite as well. As such, in such embodiments, the diversity and serving satellites also provide the diversity and serving receivers, respectively.

FIG. 2 illustrates expected gains for diversity combining for various beam strength differences between a serving reception and diversity reception, according to various embodiments.

In an Additive white Gaussian noise (AWGN) channel, an expected gain depends on a signal strength difference between a serving (main) and a diversity path. An expected gain for various signal strengths is shown FIG. 2. When the diversity combining is applied to dimly lit cells located nearly equal distance to both satellites, an approximately 2 dB improvement, or 60% higher uplink speed on the average can be expected. Although FIG. 2 illustrates an expected diversity gain for an AWGN channel, the diversity gain can be a lot higher with a multipath fading channel.

Moreover, a predetermined limit for signal strength differences may start or terminate the diversity combining. In some embodiments, the predefined limit is set as the value where the diversity gain diminishes beyond usability. The predefined limit be set arbitrarily, for example, 4 dB or 5 dB, or the like.

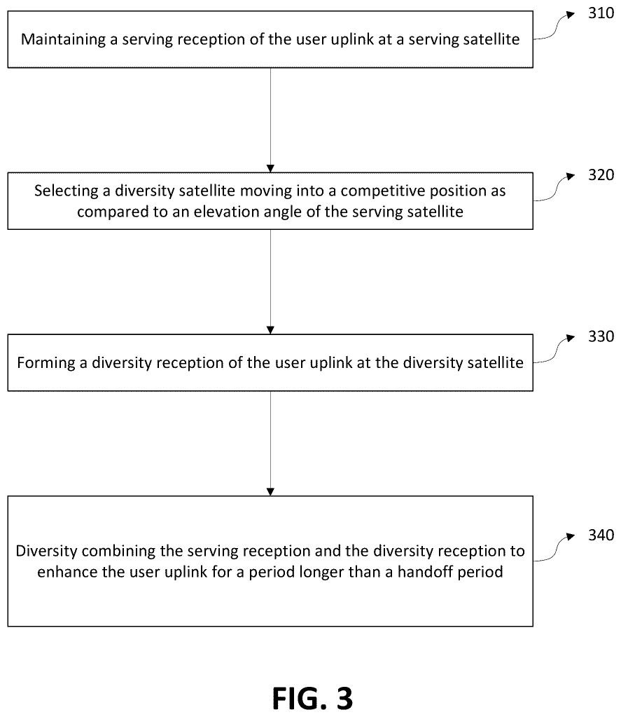

FIG. 3 is a flowchart of an example method for enhancing a user uplink for satellite communications.

A method 300 for enhancing a user uplink for satellite communications may include operation 310 for maintaining a serving reception of the user uplink at a serving satellite. Method 300 may include operation 320 for selecting a diversity satellite moving into a competitive position as compared to an elevation angle of the serving. Method 300 may include operation 330 for forming a diversity reception of the user uplink at the diversity satellite. Method 300 may include operation 340 for diversity combining the serving reception and the diversity reception to enhance the user uplink for a period longer than a handoff period.

Having described preferred embodiments of a system and method (which are intended to be illustrative and not limiting), it is noted that modifications and variations can be made by persons skilled in the art considering the above teachings. It is therefore to be understood that changes may be made in the embodiments disclosed which are within the scope of the invention as outlined by the appended claims. Having thus described aspects of the invention, with the details and particularity required by the patent laws, what is claimed and desired protected by Letters Patent is set forth in the appended claims.

We claim as our invention:

1. A process for enhancing a user uplink for satellite communications, comprising:
maintaining a serving reception of the user uplink at a serving satellite;
selecting a diversity satellite moving into a competitive position as compared to an elevation angle of the serving satellite;
forming a diversity reception of the user uplink at the diversity satellite; and
diversity combining the serving reception and the diversity reception to enhance the user uplink for a period longer than a handoff period,
wherein the diversity combining is performed while a signal strength difference between the serving reception and the diversity reception is less than or equal to a predefined limit.

2. The process of claim 1, wherein the predefined limit is 4 dB.

3. The process of claim 1, wherein the diversity combining enhances the user uplink by at least 1.4 dB at a serving receiver.

4. The process of claim 1, wherein the diversity combining is performed at a serving receiver for the user uplink.

5. The process of claim 4, wherein the serving receiver performs a channel estimation and a Doppler compensation on the serving reception and accepts the diversity reception from a diversity receiver, prior to the diversity combining.

6. The process of claim 1, wherein a diversity receiver performs a channel estimation and a Doppler compensation on the diversity reception prior to the diversity combining.

7. The process of claim 1, wherein the diversity reception is communicated via an Inter-Satellite Link (ISL) for the diversity combining.

8. The process of claim 1, wherein the diversity reception is established as the serving reception when the signal strength difference is less than the predefined limit.

9. The process of claim 1, wherein one user downlink to a user device is paired with the serving reception and the diversity reception.

10. The process of claim 1, wherein the maintaining of the serving reception is terminated to conserve a transmission power of the serving satellite.

11. A system to enhance a user uplink for satellite communications, comprising:
a serving receiver to maintain a serving reception of the user uplink at a serving satellite;
a diversity satellite to move into a competitive position as compared to an elevation angle of the serving satellite and to form a diversity reception of the user uplink at the diversity satellite; and
a diversity combiner to enhance the serving reception and the diversity reception for a period longer than a handoff period,
wherein the diversity combiner operates while a signal strength difference between the serving reception and the diversity reception is less than or equal to a predefined limit.

12. The system of claim 11, wherein the predefined limit is 4 dB.

13. The system of claim 11, wherein the diversity combiner enhances the user uplink by at least 1.4 dB at a serving receiver.

14. The system of claim 11, wherein the diversity combiner operates at a serving receiver for the user uplink.

15. The system of claim 14, wherein the serving receiver performs a channel estimation and a Doppler compensation on the serving reception and accepts input from a diversity receiver, prior to the diversity combiner.

16. The system of claim 11, wherein a diversity receiver performs a channel estimation and a Doppler compensation on the diversity reception prior to the diversity combiner.

17. The system of claim 11, further comprising an Inter-Satellite Link (ISL) to communicate the diversity reception to the diversity combiner.

18. The system of claim 11, wherein the diversity reception is established as the serving reception when the signal strength difference is less than the predefined limit.

19. The system of claim 11, wherein one user downlink to a user device is paired with the serving reception and the diversity reception.

20. The system of claim 11, wherein the serving reception is terminated to conserve a transmission power of the serving satellite.
